(19) United States
(12) Patent Application Publication
(10) Pub. No.: US 2007/0053193 A1
(43) Pub. Date: Mar. 8, 2007

(54) METHOD AND SYSTEM FOR PROVIDING INDIRECT LIGHTING

(76) Inventor: Lyonel M. JOFFRE, Atlanta, GA (US)

Correspondence Address: SMITH FROHWEIN TEMPEL GREENLEE BLAHA, LLC, P.O. BOX 88148, ATLANTA, GA, 30356, US

(21) Appl. No.: 11/162,322

(22) Filed: Sep. 6, 2005

(51) Int. Cl. B62J 6/00

(52) U.S. Cl. 362/475

(57) ABSTRACT

A lighting fixture based on the delivery of indirect lighting. A light source is embedded within a helmet which directs the light waves of the light source over light wave manipulation elements so that the light waves are deflected and/or refracted to disperse indirect lighting in proximity to the light source without having the harshness of the direct lighting, or the distraction of the light bulb's visibility.

### BACKGROUND OF THE INVENTION

“Let there be light”. One of man's early objectives in his attempt to control the forces of nature was to establish dominance over darkness. The first step in this quest was learning how to start a fire. As a result, this control led to the development of candles and oil lanterns. As the world moved into the realm of electricity, these innovations gave rise to the development of electric light or the electric light bulb. Although Thomas Edison of the United States is most widely recognized as the inventor of the light bulb, there were others quite involved in the process as well. As early as 1811, Sir Humphrey Davy discovered that passing an electrical arc between two poles produced light. This technology was actually incorporated into various experimental products what were used in the Place de la Concorde in Paris in 1841, as well as other European and American locations. However, this technology was unreliable in the operational life of the product was rather short. The next monumental step in this inventive process was discovering that electricity passing through a highly resistant conductor would glow white-hot as the heat energy turned into luminous energy. The only hurdle to be overcome was figuring out how to get the filament into an oxygen free environment—as the oxygen would result in allowing the filament to quickly burn up.

Sir Joseph Wilson Swan of England was the first to construct an electric light bulb that included an internal filament. However, Swan was unable to successfully maintain a vacuum in his bulb. As the oxygen was leak into the bulb, Swan's filaments were then consumed. Edison discovered how to successfully maintain a vacuum within a bulb and, on Oct. 21, 1879, he illuminated a carbon filament light bulb that glowed continuously for 40 hours.

Over the years, light has remained a fundamental necessity for modern civilization but, another remarkable development has been realized—the decorative or aesthetic appreciation for the various nuances and characteristics of light. Thus, we now have the appreciation for party lights, laser shows, Christmas lights, lava lamps and even the artistic aspects of lighting in photography, paintings and live art through modification and distortion of light and various light waves.

Another development in lighting technology has been in the ornamental or decorative aspects of light sources. Elaborate lamps chandeliers and light fixtures have been developed to further enhance the aesthetic pleasure in the delivery of light. However, a common problem with chandeliers and light fixtures is the harshness aesthetically displeasing appearance of the light bulb itself. To deliver an adequate amount of light, it is necessary for the light bulb to be visible to the casual observer. One technique that has been used to address this issue has been the development of decorative light bulbs, frosted light bulbs and even light bulbs that are partially opaque. Although this technique has somewhat alleviated the harshness that is apparent when the light bulb is directly visible as well as the aesthetically displeasing appearance, it has not fully addressed and alleviated the issue. Thus, there is a need in the art for a technique to enhance the aesthetic delivery of light.

### BRIEF SUMMARY OF THE INVENTION

The present invention solves the above-listed needs in the art, as well as other needs, through providing a system and method for providing indirect lighting that is based on deflecting and/or refracting light waves from a concealed, or at least partially concealed light source. Advantageously, the various embodiments of the present invention allow for an adequate amount of light is able to be delivered to a desired area, without diminishing the aesthetic attributes of the lighting fixture and limiting the harshness attributable to direct lighting.

In one embodiment of the present invention, a light source is embedded within a helmet which results in directing the light waves over light wave manipulation elements so that the light waves are deflected and/or refracted to disperse indirect lighting in proximity to the light source without having the harshness of the direct lighting, or the distraction of the light bulb's visibility. In another embodiment, the invention is incorporated into a light fixture that can be hung on the wall. In yet another embodiment, the invention is incorporated into a chandelier. The invention may also be embodied in a free standing component configuration in which the deflector/refractors are positioned in proximity to the light source but independent from the light source. Such embodiments can be used for providing decorative lighting over a large area, such a building, bill-boards, artwork, etc. Other embodiments can be used to simply light a pathway, or a front porch stoop. Other uses and embodiments of the present invention are also anticipated and will be appreciated by those skilled in the art.

### BRIEF DESCRIPTION OF THE SEVERAL VIEWS OF THE DRAWING

FIG. 1 is a conceptual drawing of one configuration of the present invention.

FIGS. 2A-2C illustrate three additional, but non-limiting examples of shapes for the helmet.

FIG. 3 is a diagram illustrating a concealing helmet with an access door.

FIG. 4 is a perspective drawing of one embodiment of various aspects of the present invention.

FIG. 5 is a perspective drawing illustrating another embodiment of aspects of the present invention. In this embodiment, a light source 511 is located and operated within fixture 510.

FIG. 6 is a perspective drawing illustrating another embodiment of aspects of the present invention. In this embodiment, a light source 611 is located and operated within fixture 610.

FIG. 7 illustrates an embodiment for connecting a deflector/refractor to the surface of a light fixture employing aspects of the present invention.

### DETAILED DESCRIPTION OF THE INVENTION

The present invention is directed towards a unique and novel approach to providing indirect lighting. One aspect of the present invention includes a concealed light source that directs lights over one or more light controlling or manipulating surfaces. Another aspect of the present invention is a light source that simply directs light waves upward to a light controlling or manipulating surface when then directs the light waves in a downward direction. Another aspect of the present invention is an array of light controlling and/or manipulating elements that can be fixed into position for a particularly desired lighting effect or, that can be manipulated by a user or designer to create varying effects. These and other specific aspects of the present invention will be more fully described with reference to the various figures in which like numerals represent like elements throughout the several views.

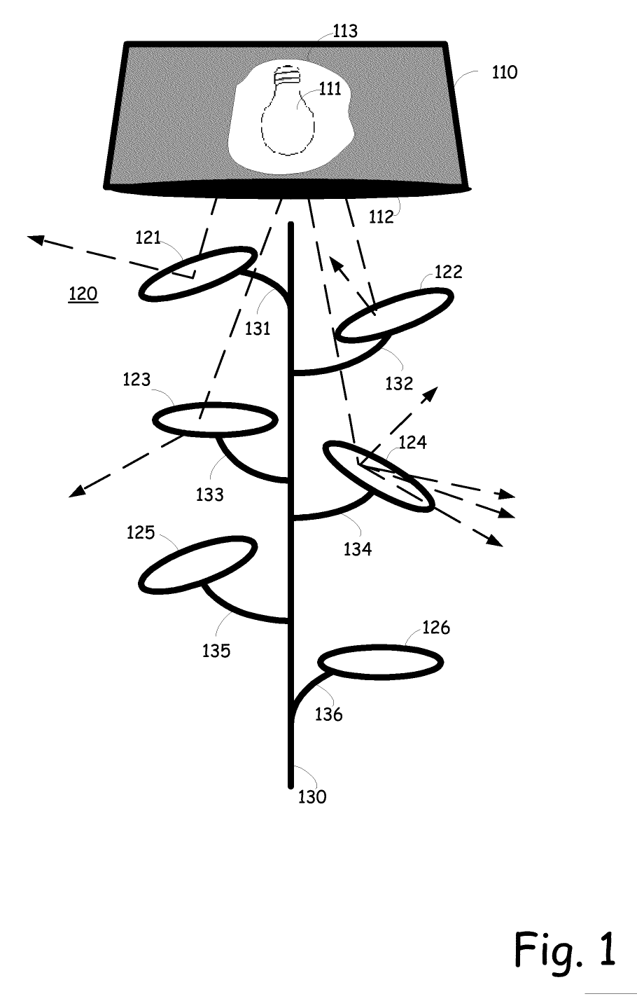

FIG. 1 is a conceptual drawing of one configuration of the present invention. In this embodiment, a helmet 110 houses a light source 111. The helmet 110 substantially or completely conceals the light source from the typical viewer (i.e., a viewer that is simply walking by or in view or the proximity of the light source). In FIG. 1, the light source 111 is shown as visible to the reader but it should be appreciated that the light source 111 is actually internal to the helmet 110 and the x-ray opening 113 if provided to the reader just for understanding. The helmet 110 includes an opening 112 for directing light waves from the light source in at least one direction. In the illustrated embodiment, the opening 112 allows the light waves to be directed in a generally downward direction; however, it should be understood that the downward direction of the light waves is only a representative example of one aspect of the invention and, although this particular aspect may in and of itself provide novelty, is not the only anticipated embodiment or aspect of the present invention. In fact the present invention can be incorporated into multi-directional embodiments in any of a variety of directions, as well as omni-directional embodiments.

A light controlling or manipulation array 120 is placed within the line-of-site of the light waves exiting the helmet 110. The array 120 can consist of one or more surfaces or light wave manipulation elements that can be used to deflect, alter, filter, refract and/or otherwise manipulate the light waves. In the illustrated embodiment, the manipulation elements 121-126 are positioned below the opening 112. At least a portion of the light waves exiting the opening 112 strike the surface of a manipulation element and, depending on the physical characteristics of the manipulation element, the light waves are deflected and/or refracted in one or more directions as illustrated in FIG. 1. As those skilled in the art will be aware, when light hits a solid and opaque surface, portions of the light waves are deflected from the surface in one or more directions, while some of the light waves are absorbed. The light waves that are absorbed depend on the color and material of the surface. In addition, Snell's law basically states that as light waves pass from a first medium into a second medium, the light waves will be refracted. The amount of refraction will depend on the light conducting characteristics of the two mediums. If the manipulation elements are transparent or translucent, then a portion of the light waves will pass through the manipulation elements and be refracted in the process. The manipulation elements may also be light filters that will only allow portions of the light spectrum to pass, or may be a prism that divides the light waves out. It should be appreciated that a variety of materials can be utilized for the manipulation elements and in fact, the elements may be constructed of a composite of materials having similar and/or different light manipulation attributes.

In the illustrated embodiment, the array 120 is shown as consisting of a plurality of manipulation elements 121-126. It should be appreciated that the array 120 may take on a variety of shapes, sizes and characteristics. In one embodiment, each of the manipulation elements 121-126 can be moved and repositioned by bending the wire or rod (respectively 131-136) that connects them to a central branch 130. In addition, the central branch 130 or the manipulation elements 121-126 may also be bent or manipulated into various shapes. Thus, it will be appreciated that the array 120 can be adjusted in such a manner to have varying effects on the light waves from the light source 111. In alternative embodiments, the array 120 may be rigid or substantially rigid and forced into a particular configuration that is not readily alterable.

The light wave manipulation elements 121-126 may take on a variety of forms and the various manipulation elements in a single array unit may include uniformly shaped and constructed elements or drastically differing elements. As a non-limiting example, the manipulation elements may be made of materials including transparent material, translucent material and opaque material. The manipulation elements may be made from glass, crystal, gems, stones, plastic, metal, wood or any of a variety of natural or synthetic materials. In addition, each manipulation element may be made of a combination of one or more materials having one or more characteristics. The manipulation elements may also be implemented in a variety of shapes and sizes and be painted using a variety of techniques.

In one embodiment, the deflector/refractor is constructed of a metallic material. The manipulation elements can be formed in the shape of leaves and then painted with a dark color mixed with a lighter reflective color. In another embodiment, the deflector/refractor is constructed of rounded and tinted glass manipulation elements that are all tied together with wires or strings, such as in the shape of a cluster of grapes. Those skilled in the art will appreciate that the present invention can be applied to a variety of different forms for the deflector/refractor array and the present invention should not be limited to any particular configuration or the examples provided herein.

In general, the invention as illustrated in the above-described embodiments basically includes a concealed, or substantially concealed light source, and a deflector/refractor element that allows the light waves from a light source to be redirected in a manner to provide indirect lighting. Advantageously, this embodiment of the present invention allows for the harshness of the direct lighting to be alleviated, as well as the unsightliness of the light source.

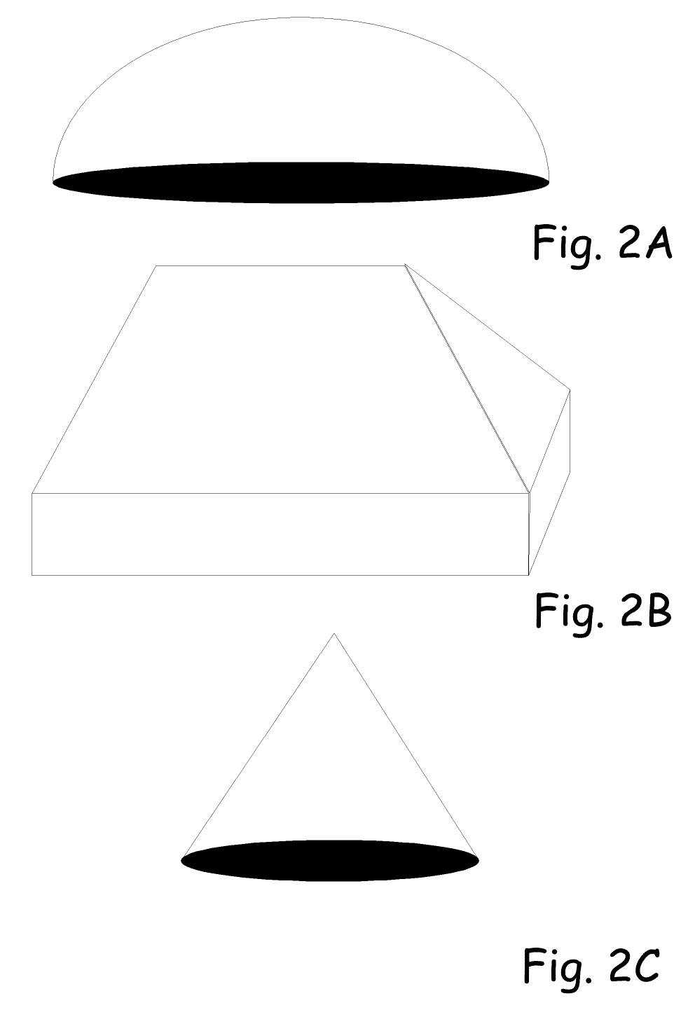

The helmet 110 illustrated in FIG. 1 is only one embodiment and it should be appreciated that the helmet may take on a variety of shapes and sizes. FIGS. 2A-2C illustrate three additional, but non-limiting examples of shapes for the helmet.

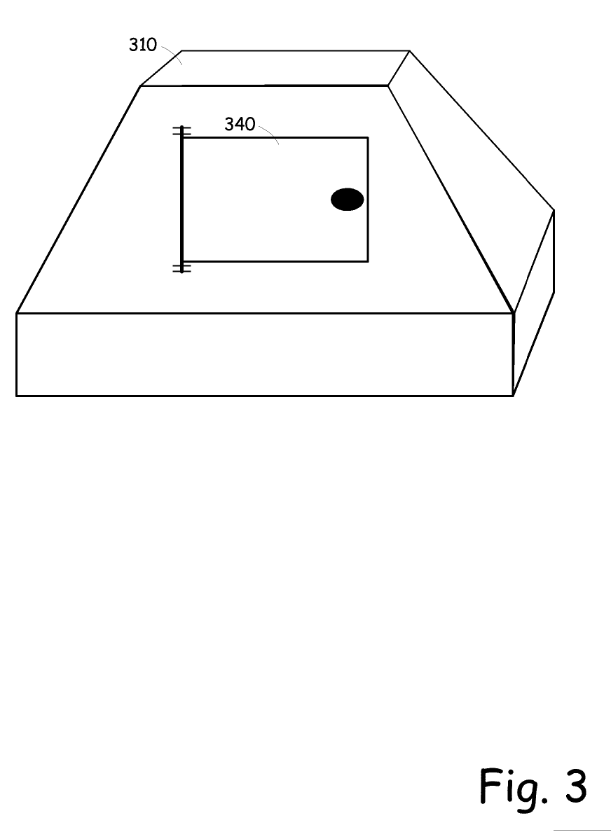

FIG. 3 is a diagram illustrating a concealing helmet with an access door. FIG. 3 illustrates another aspect of the present invention which is to include an access door 340 within a side, including a top side or bottom side, of the helmet to allow a user to gain access to the light source for cleaning and/or replacement. The access door 340 may include a variety of mechanisms including a hinge with or without a locking mechanism, a sliding door, a removable panel, or the like.

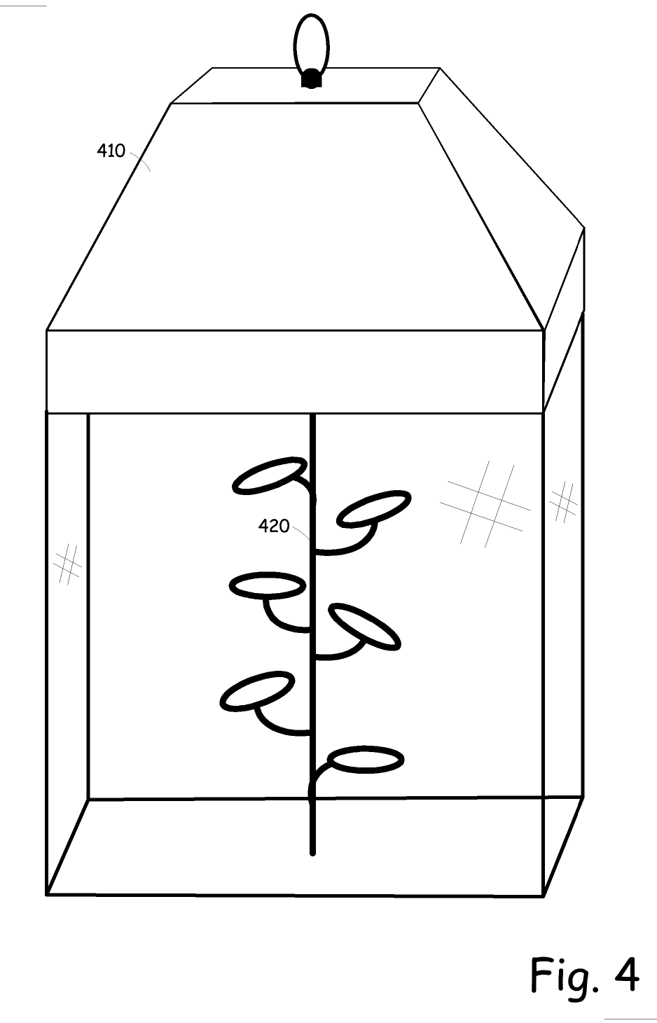

FIG. 4 is a perspective drawing of one embodiment of various aspects of the present invention. In this embodiment a helmet 410 is used to conceal a light source (not shown). A manipulation array 420 is located in the path of light waves exiting the helmet 410. Further, in this embodiment the invention is encapsulated within a light fixture that can either be attached to a wall or hung from a ceiling using techniques familiar to those skilled in the art. For instance, the light fixture may include three glass panels, or open sides, and one closed side with the closed side being placed flush against a wall. Alternatively, all fours sides of this fixture may include glass panels and/or be open with the light fixture being hung from the ceiling. Advantageously, it will be appreciated that the harshness of the light source is hidden from direct view by the helmet 410, and the light waves exiting the helmet 410 are either deflected or refracted when they come in contact with the deflector/refractor 420. Thus, the light fixture provides indirect lighting for the user's enjoyment.

In fixture embodiments that incorporate glass panels, the glass panels may be of any of a variety of forms including, but not limited to clear, seedy, frosted, tinted, water, crackled, painted, beveled, leaded, etc. In fixture embodiments that incorporate solid, non-glass panels, the panels may be of any of a variety of materials including metal, wood, plastic etc. The panels may have holes in them, be partially translucent, include any of a variety of paints and textures, as well as any of a variety of reflective materials.

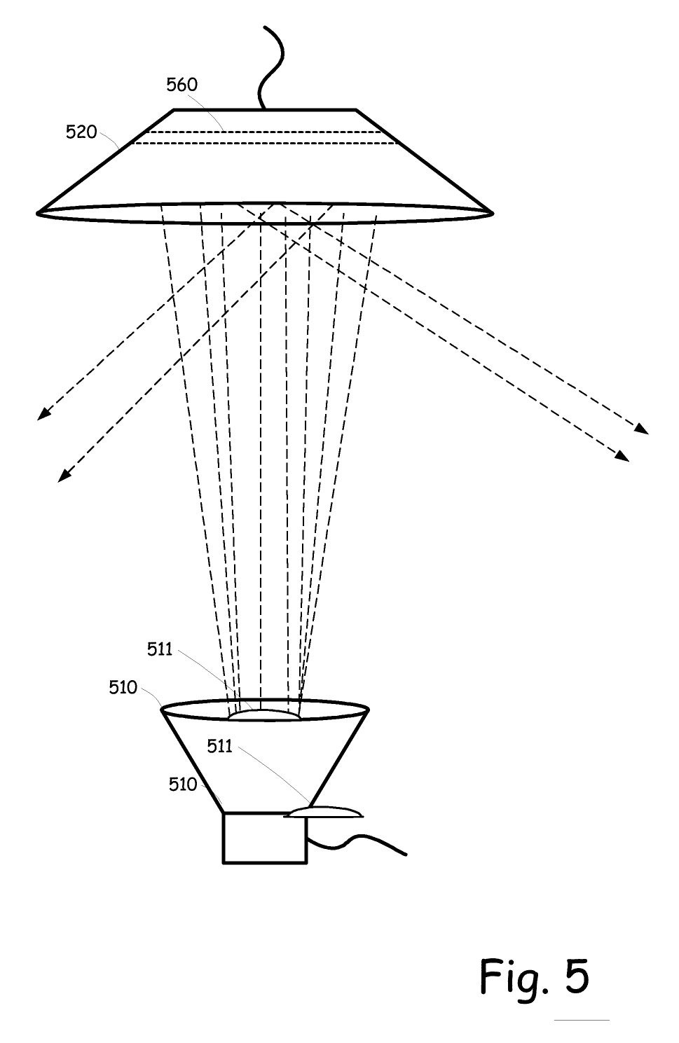

FIG. 5 is a perspective drawing illustrating another embodiment of aspects of the present invention. In this embodiment, a light source 511 is located and operated within fixture 510. The light waves in this embodiment are directed in an upward direction towards manipulation array 520. The light waves are then redirected as a result of striking the manipulation array 520 and thus, provide indirect/manipulated lighting. It should be appreciated that in the illustrated embodiment, the light waves are shown as being deflected, however, the manipulation array 520 may be partially or fully constructed of a transparent and/or translucent material that would result in refraction of at least portions of the light waves or other materials for other controlling characteristics. For instance, the manipulation array 520 may include prisms, filters, crystals, etc. IN addition, the helmet may include light manipulation elements such as the glass element illustrated by the dashed element 560 to allow some of the light waves to exit the helmet 510.

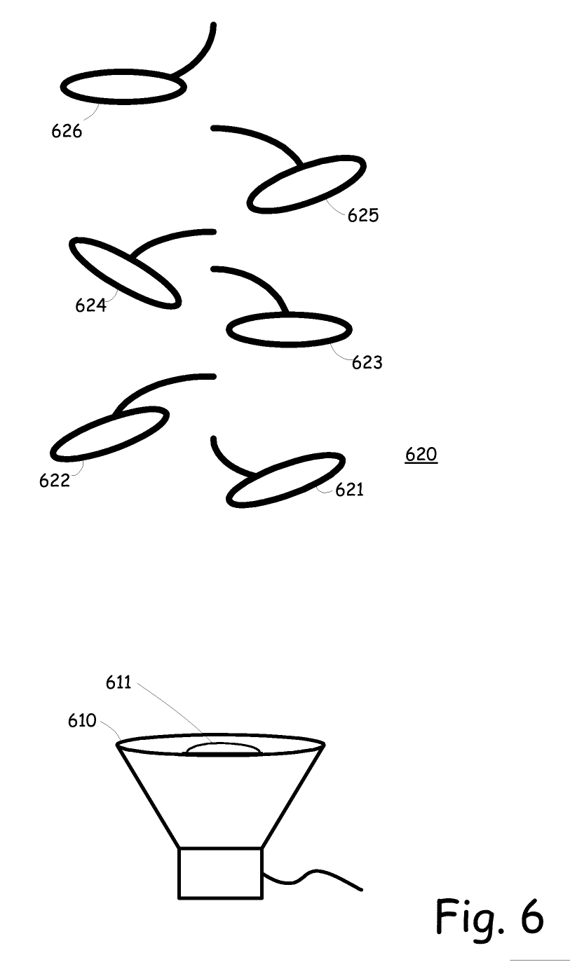

FIG. 6 is a perspective drawing illustrating another embodiment of aspects of the present invention. In this embodiment, a light source 611 is located and operated within fixture 610. The light waves in this embodiment are directed in an upward direction towards the deflector/refractor 620 which includes a plurality of light wave manipulation elements 621-626. This embodiment of the present invention is advantageously beneficial for use in road, walkway and landscape lighting uses.

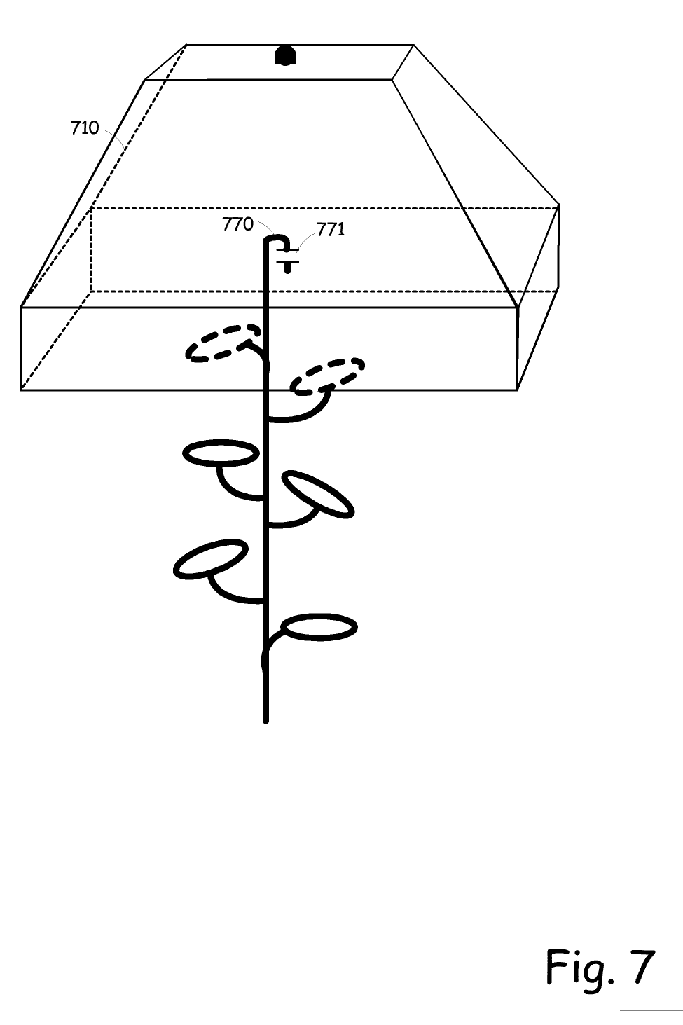

FIG. 7 illustrates an embodiment of the present invention for connecting a deflector/refractor to the surface of a light fixture employing aspects of the present invention. In FIG. 7, the deflector/refractor has a hooked end 711 which is inserted into a flange or flap 712 of the helmet 710. It should be appreciated that in any of the light fixture embodiments, the deflector/refractor can be connect in such a manner, or a similar manner to either the hood, a side wall of the fixture or even the bottom surface, if any, of the fixture. Other techniques are also anticipated.

For embodiments of the present invention that are more component oriented, such as those illustrated in FIGS. 1, 5 and 6, the deflector/refractor may be mounted to other surfaces, suspended from the helmet, or suspended upward from a ground surface. In another embodiment, the light manipulating array as shown in the various embodiments may be constructed of interchangeable elements. Thus, depending on the desired indirect lighting characteristics, a user can install a variety of elements as described herein to change the lighting effects.

It should be appreciated that the concealment of the light source is only one aspect of the present invention and other aspects of the invention can be utilized within embodiments that do not include the concealed lighting source aspect.

The present invention may be implemented in a variety of sizes and form factors. For instance, the invention may be incorporated into a multi-light bulb, ballroom chandelier or into a simple, plug in the wall night light.

Various embodiments of the present invention have been described. Examples have been provided for descriptive purposes and the described examples should not be used to limit the scope of the present invention. It is recognized that changes, variations and modifications may be made to the various embodiments of the present invention without departing from the spirit and scope thereof.

What is claimed is:

1. A method of providing indirect lighting comprising:
concealing a light source within a helmet;
directing light waves of the light source out of at least one opening in the helmet;
positioning a plurality of light manipulation elements in proximity to the at least one opening in the helmet, whereby the light waves from the light source strike the plurality of light manipulation elements and as a result provide indirect lighting.

2. The method of claim 1, where in the step of positioning a plurality of light manipulation elements further comprises placing an array of adjustable light manipulation elements thereby allowing a user to adjust the characteristics of the indirect lighting.

3. An indirect lighting fixture comprising:
a helmet operable to receive and at least partially conceal a lighting source;
a light emitting opening in the helmet to allow light waves from a lighting source to exit the helmet;
an array of light manipulation elements positioned in proximity to the light emitting opening in the helmet.

4. The fixture of claim 3, wherein the helmet is affixed to a lighting chamber that includes a plurality of glass panels around the entire circumference of the lighting chamber and is operable to house the array.

5. The fixture of claim 3, wherein the helmet is affixed to a lighting chamber that includes at least one glass panel and is operable to house the array.

6. The fixture of claim 5, wherein the array includes a plurality of elements that can be individually adjusted.

7. The fixture of claim 5, wherein the array includes a plurality of light reflecting elements that can be individually adjusted.

8. The fixture of claim 5, wherein the array includes a plurality of light refracting elements that can be individually adjusted.

9. The fixture of claim 5, wherein the array includes a plurality of light manipulation elements that can be interchanged with elements having differing light altering characteristics selected from the group of refractors, reflectors, deflectors, filters and prisms.

10. The fixture of claim 5, wherein the array is removably attached to a surface of the helmet and can be interchanged with an alternate array.

11. A lighting fixture comprising:
a helmet operable to receive and at least partially conceal a lighting source;
a light emitting opening in the helmet to allow light waves from a lighting source to exit the helmet;
a light manipulation element positioned in proximity to the light emitting opening in the helmet.

12. The fixture of claim 11, wherein the helmet is affixed to a lighting chamber that includes a plurality of glass panels around the entire circumference of the lighting chamber and is operable to house the light manipulation element, the light manipulation element comprising a plurality of light altering surfaces that can be individually adjusted.

13. The fixture of claim 12, wherein the light altering surfaces have light altering characteristics selected from the group of refractors, reflectors, deflectors, filters and prisms.

14. The fixture of claim 12, wherein the helmet is attachable to a ceiling mounting.

15. The fixture of claim 11, wherein the helmet is mountable to a lower surface and the light manipulation element is positioned above the helmet.

16. The fixture of claim 11, wherein the helmet is affixed to a lighting chamber that includes at least one glass panel and is operable to house the light manipulation element, the light manipulation element comprising a plurality of light altering surfaces that can be individually adjusted.

17. The fixture of claim 16, wherein the light altering surfaces have light altering characteristics selected from the group of refractors, reflectors, deflectors, filters and prisms.

18. The fixture of claim 11, wherein the helmet includes an access door for providing access to the light source.

19. The fixture of claim 11, where the light manipulation element can be interchanged with a plurality of light manipulation elements.

20. The fixture of claim 11, wherein the light manipulation element is removably attachable to a surface of the helmet.
